(19) United States
(12) Patent Application Publication
(10) Pub. No.: US 2018/0137179 A1
(43) Pub. Date: May 17, 2018

(54) SYSTEMS AND METHODS FOR DIGITAL PRESENCE PROFILER SERVICE

(71) Applicant: Cofame, Inc., Palo Alto, CA (US)

(72) Inventor: Hitoshi Kawanabe, Palo Alto, CA (US)

(21) Appl. No.: 15/814,359

(22) Filed: Nov. 15, 2017

Related U.S. Application Data
(60) Provisional application No. 62/422,466, filed on Nov. 15, 2016.

(51) Int. Cl. G06F 17/30

(52) U.S. Cl. CPC G06F 17/30542; G06F 17/30864; G06F 17/30554

(57) ABSTRACT

A method is provided that includes receiving, from a user, a request related to a target and determining if one or more records in a repository are associated with the target. Each record includes identifiers for retrieving digital activity associated with an individual from a plurality of environments. The method further includes generating one or more new record based on identifiers from a directory service related to the target and not associated with a record in the repository; retrieving digital activity based on the one or more records from the repository, new records, and the user record associated with the request; determining a target profile based on at least the retrieved digital activity associated with the user record; generating a response based on digital activity for the target profile; and transmitting the response.

### RELATED APPLICATION INFORMATION

This application is a continuation of U.S. Provisional Patent Application No. 62/422,466, filed on Nov. 15, 2016, which is incorporated herein by reference in its entirety as set forth in full.

### FIELD

Aspects of example implementations relate to at least a system and method for servicing a request from a user with information about a target individual based on retrieved digital activity associated with the target individual. Additional aspects of the example implementations relate to generating records of linked identifiers for target individuals using data analytics and validation techniques.

### BACKGROUND

An individual's digital presence includes varying levels of access to their information by other individuals or systems. For example, an individual's private digital presence may be locally stored and inaccessible to others, a professional digital presence may be on a firewalled employer intranet, and an online presence generally exists on the Internet.

An individual's digital presence includes information that is personally identifiable to the individual that may be controlled or generated by the individual or others. For example, an individual's digital presence can include content distributed across social media websites generated by the individual or content about the individual generated by others persons, biographical information published by directory services, data stored in network connected databases, etc. The information accessible about other people's digital presence can depend on the digital presence of the party requesting the information.

Conventional tools to access information about a target individual's digital presence typically require a requesting party to provide a high degree of information about the target individual, are limited to publically accessible sources, include outdated or irrelevant information (e.g., information about a different individual that may be similar to the target individual), and typically are not useful for interacting (real world or digitally) with the target individual. An individual desiring to engage a target individual typically manually checks the target individual's digital presence by running online searches on a few sources. For example, prior to a meeting with a new acquaintance, a person may check the new acquaintance's social media posting, biographical information, news stories, etc. in order to effectively engage the new acquaintance.

Every digital source typically generates and assigns its own identifiable tag for tracking and organizing data about individuals. For example, Internet tracking tools may use a device identifier or location indicator to tag and track repeat visits or activity across a selection of online sources. Advertising services typically crawl sections of the online universe to collect quadrillions of records and analyze the data for advertising purposes. Some digital sources require individuals to register with a provided identifier such as an email address or username. Therefore, an individual with a digital presence typically has hundreds or thousands of different identifiers that can be associated with their digital presence.

Typically, a person has limited identifiable information about a new acquaintance in order to efficiently determine the new acquaintance's digital presence. Further, if a person has little advance notice of a meeting with a new acquaintance, even with a high degree of identifiable information, a person is unable acquire up-to-date information associated with the new acquaintance's digital presence. Therefore, it is impractical and sometimes impossible to identify individual's digital presence and perform data analysis to identify relevant information based on the person requesting the data.

Accordingly, there is an unmet need for a service to provide up-to-date information about a target individual's digital presence across several online sources in real-time and present intelligent reporting to service a request.

### SUMMARY

According to an example implementation, a computer-implemented method is provided. The method includes receiving, from a user, a request from a user related to a target individual and determining if one or more records in a repository are associated with the target individual. Each record includes identifiers for retrieving digital activity associated with an individual from a plurality of environments. The method further includes generating one or more new records based on identifiers from a directory service related to the target and not associated with a record in the repository; retrieving digital activity based on the one or more records from the repository, new records, and the user record associated with the request; determining a target profile based on at least the retrieved digital activity associated with the user record; generating a response based on digital activity for the target profile; and transmitting the response. The methods are implemented using one or more computing devices and/or systems. The methods may be stored in computer-readable media. In an example implementation, the method is a cloud service that can service requests from other platforms via an application interface.

### BRIEF DESCRIPTION OF THE DRAWINGS

FIG. 1 illustrates a block diagram of an example system in accordance with one or more implementations of the present disclosure;

FIG. 2 illustrates an example of a digital presence profiler in accordance with one or more implementations of the present disclosure;

FIG. 3 is a flow diagram of an example method in accordance with one or more implementations of the present disclosure;

FIG. 4 is a illustrates example record data in accordance with one or more implementations of the present disclosure;

FIG. 5A illustrates an example digital activity payload in accordance with one or more implementations of the present disclosure;

FIG. 5B illustrates example user interactions to retrieve digital activity payload in accordance with one or more implementations of the present disclosure;

FIGS. 6A-B illustrate example digital presence checker in accordance with one or more implementations of the present disclosure.

FIGS. 7A-B illustrate example digital presence scoring and tracking interfaces in accordance with one or more implementations of the present disclosure;

FIG. 8 illustrates a block diagram of one implementation of a computing device.

FIG. 9 illustrates an example computing environment with an example computer device suitable for use in some example implementations;

FIG. 10 provides a block diagram illustrating an example computing device or system that may be used in connection with various example implementations described herein;

### DETAILED DESCRIPTION

The subject matter described herein is taught by way of example implementations. Various details have been omitted for the sake of clarity and to avoid obscuring the subject matter. The examples shown below are directed to structures and functions for implementing systems and methods for determining a target individual's digital activity using limited user provided identifying information.

According to an example implementation, a system and method is provided for digital presence profiler to service requests from a user. The digital presence profiler can provide the service via communication interfaces that can interact with other platforms such as artificial intelligence platforms, messaging service, user devices, online portals, etc. that allow the user to interact with the digital presence profiler. For example, the digital presence profiler includes an Application Program Interface for receiving requests. In another example, the digital presence profiler can include a user interface to directly interact with the user. The user may employ any electronic device such as, but are not limited to, smartphones, tablets, laptops, computers, telephones (mobile or non-mobile), microphones, camera, and other wireless communication devices to send requests and receive a digital activity report in response to the request.

For example, a request might include “Do I know anyone who speaks Chinese?” and the digital activity report can respond “Zhao Wei, Fan Bingbing, and Jian Tian can speak Chinese.” In another example, a request might include “I'm going to Hawaii. Do I know anyone who has been there?” and the digital presence profiler can use the requesters user data to search social media connections for biographical information, pictures, postings, etc. associated with Hawaii.

The digital presence profiler may include, but is not limited to, a set of instructions capable of being executed in a non-transitory computer readable medium. The instructions may reside in an electronic device at the side of the user (e.g., the client side), at a remote location (e.g., a server side or in a cloud computing environment), or a combination thereof, or on other client devices in a shared processing environment.

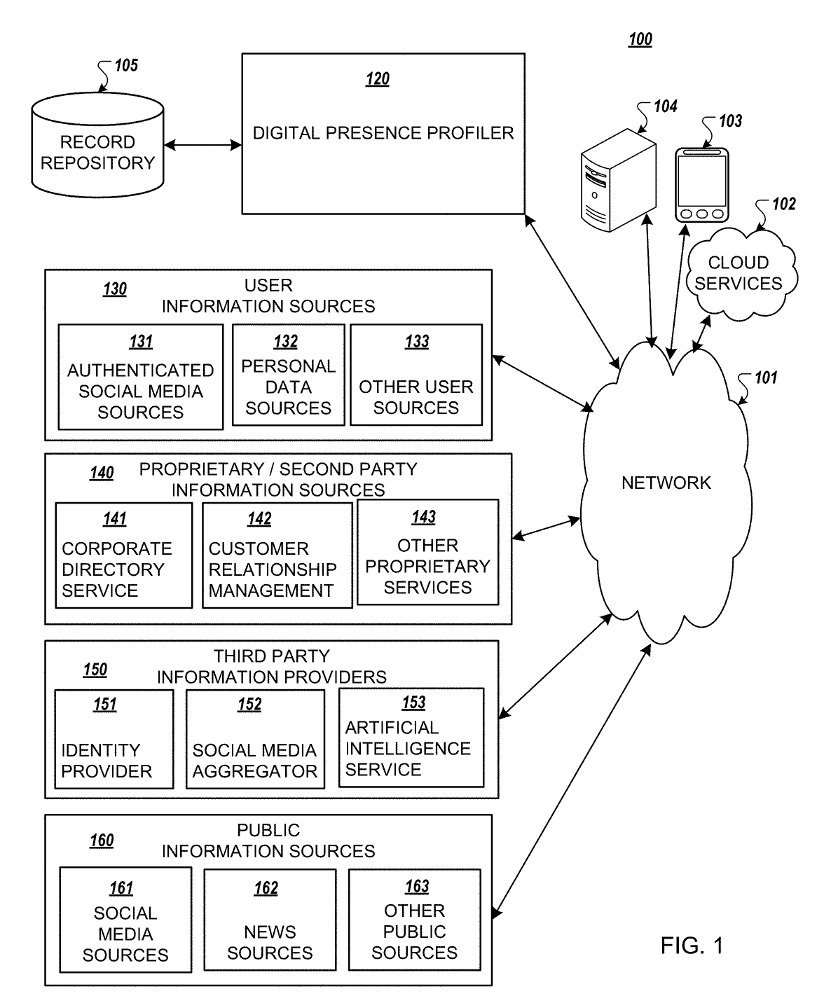

FIG. 1 illustrates a block diagram of an example system 100 in accordance with one or more implementations of the present disclosure. System 100 can include one or more networks that can connect to multiple environments or online sources, for example, user information sources 130, proprietary information sources, third-party information providers, public information sources, etc. The digital presence profiler 120 can receive requests via the network 101 from various platforms or sources such as cloud services, artificial intelligence platforms, messaging platform, user devices, Internet of Things devices, websites, etc.

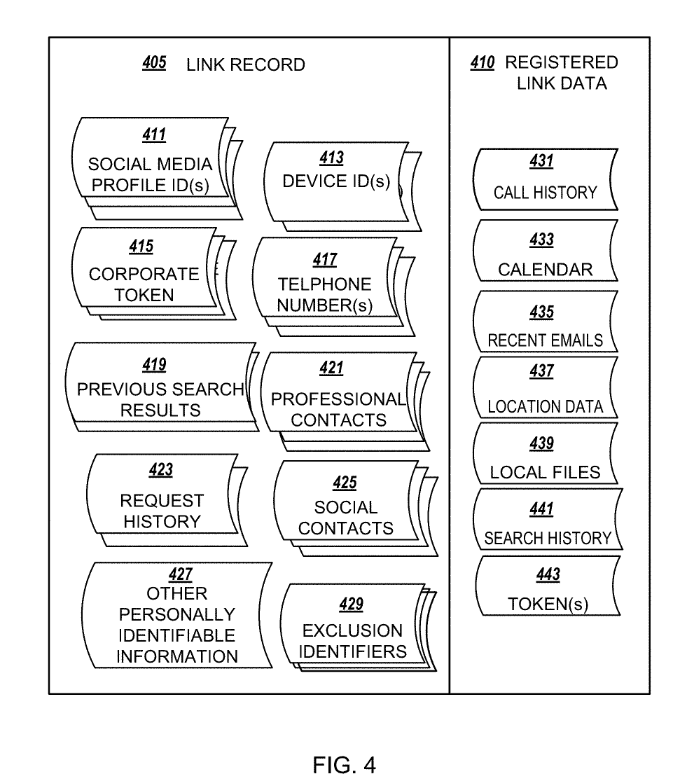

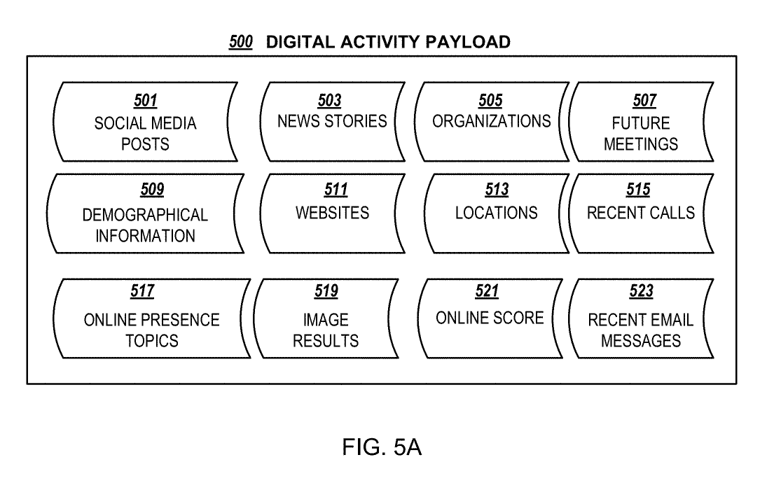

The system 100 may also include one or more storage devices such as a record repository 105 or cloud storage 102. In an example, a record repository 105 stores identifier link tables as discussed in reference to FIG. 4. The digital presence profiler 120 can be hosted by a cloud service 102 or one or processors of a computing device 103 or 104. The digital presence profiler 120 is network 101 accessible by cloud services 102, computing devices 103, 104 or other network service such as virtual digital assistances.

The digital presence profiler 120 can include one or more application program interfaces (API) to connect via networks 101to the various sources. Account identification for a registered user can be stored in the record repository 105. The digital presence profiler 120 can use records in the repository 105 to access the account identification of the registered users. Further, multiple information sources 130-160 may be accessed by the digital presence profiler 120 to gather digital activity from, for example, authenticated social networking services 131 and public information form social networking sources 161. For example, the digital presence profiler 120 may login to the social networking service as the user, and send one or more search queries automatically on behalf of the user to the social networking service for data related to the target individual. The digital presence profiler 120 can interact with networking service 130-160 on behalf of registered users with authentication information stored in a record in the repository. APIs may connect to each online source for collecting digital activity. Each API is ‘generally’ provided by each Network Service, e.g. Facebook, LinkedIn.

The digital presence profiler 120 can connect to various digital sources 130-160 in order to perform real-time intelligent searching by combining identifiers from various sources, generate robust search queries, validate the search results based on user data, and determine user centric search results for unassociated individuals. User information sources 130 can include, for example, authenticated social media sources 131, personal data sources 133, or other user sources 133. Proprietary information sources 140 can include, for example, a corporate directory service 141, customer relationship management 142, or other proprietary services 143.Third-party information providers 150 can include, for example, identity provider services 151, social media aggregators 152, artificial intelligence services 153, or other third part information providers. Public information sources 160 can include, for example, publicly published information from social media sources 161, news sources 162, search engines, or other public sources 163.

The digital presence profiler 120 can receive a request for information about a target individual from a user of an artificial intelligence platform, analyze the digital activity of the requesting user to accurately identify digital activity associated with the target individual. For example, a user can request the telephone number of a new acquaintance with a very common name by saying the very common name into a voice recognition interface. The digital presence profiler 120 can conduct a searches to identify telephone numbers, for example, searching public information sources 160 available on the Internet for telephone numbers associated with the very common name, access proprietary information sources 140 with the user's authentication information sources 130 to identify additional telephone numbers associated with the very common name that are not publicly available, requests additional identifiers associated with the very common name from third-party identity providers, and/or further search for telephone numbers associated with the additional identifiers.

Based on an initial search, the digital presence profiler 120 analyzes the user's digital activity to identify potential search results that correspond to the user's digital activity. For example, analyzing the user's location data, the digital presence profiler 120 can determine the user recently traveled to a geographic location and consider telephone numbers associated with the common name in that geographic location.

The digital presence profiler 120 may also request or prompt additional information from the user. For example, the digital presence profiler 120 may have search results narrowed down to a subset based on the user's geographic location data, and request the user provide a timeframe of the last contact with the new acquaintance. Then the digital presence profiler 120 can further narrow down the subset based on timestamps of the location data for the user, or calendar information of the user, etc.

The digital presence profiler 120 may also collect digital activity of potential targets to further validate the data. In the example of the new acquaintance with a very common name, digital activity of the potential targets may further indicate a correlation or conflict between the user activity and the correct target. Accordingly, the digital presence profiler 120 is able to provide user centric results using limited identifiable information to provide information about another individual's digital activity regardless if the requesting user and the other individual have any pre-existing relationship.

Further, both the user and the other individual do not have to be registered with the digital presence profiler 120. Using third-party identity providers 151, the digital presence profiler 120 can generate validation data for an unregistered user by conducting searches based on a key identifier. For example, if a request that includes the targets email address, identifiers associated with the email address can be instantly accessed from third-party identity providers 151, additional identifiers can be gathered from searching public information sources 160, and the digital presence profiler 120 can analyze the results and transform the data into a relaxed data set. In some implementations the digital presence profiler 120 performs data transformation to develop fuzzy search queries with suggested search terms, normalized identifiers, and determines exclusion factors to accurately collect digital activity data associated with the targets email address or other identifier. In an example implementation, elastic searching can be used to develop results from multiple sources by dividing indices into subsets with nodes to coordinate delegating operations that manage subsets which can have zero or more replicas.

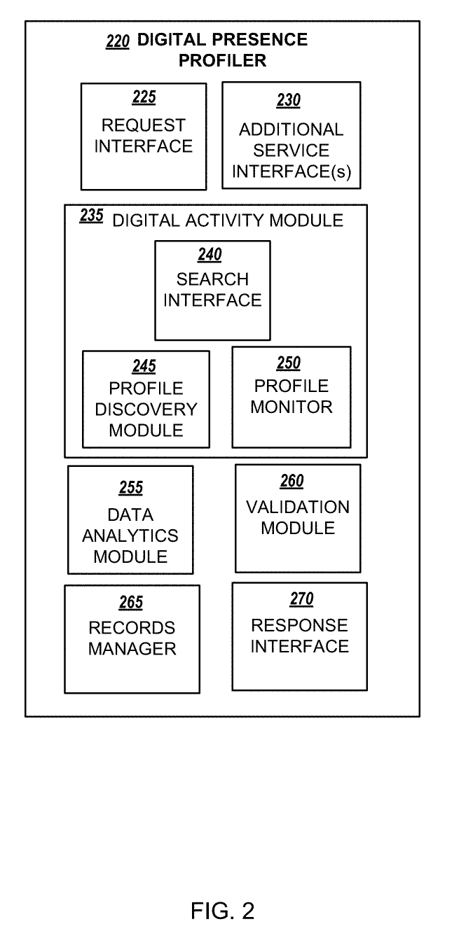

FIG. 2 illustrates an example of a digital presence profiler 220 in accordance with one or more implementations of the present disclosure. The digital presence profiler 220 includes interfaces, such as a request interface 225 and additional service interfaces 230 for accessing varicose digital sources. For example, a request interface 225 can be an input/output interface capable of communicating with user connected platforms to send and receive user feedback.

Additional service interfaces 230 can connect with APIs, online sources, cloud services, search sources, device interfaces, etc. The digital presence profiler 220 uses data gathered from digital sources as well as information available from user activity. In an example implementation, a global positioning system (GPS) device of the phone may be used to locate the device of the user and report location data. This may also be done by other means, such as Wi-Fi, Bluetooth or other wireless communication standards or methods.

The digital presence profiler 220 includes a digital activity module 235, a data analytics module 255, a validation module 260, a records manager 235, and/or a response interface 270.

The digital activity module 235 can manage digital activity using a search interface 240, a profile discovery module 245, and/or a profile monitor 250. The search interface 240 conducts queries and gathers data using combinations of search functionality across multiple sources, such as, indexing, clustering, linking, centralizing, logging, mapping, federating, context searching, fuzzy searching, elastic searching, etc. For example, in response to a user request or data management processing, the search interface 240 generates multiple queries that can iteratively search targeted sources or broadly discover results that are further processed via the data analytics module 255 and validation module 260.

The profile discovery module 245 extracts identifiers and tracks source that can be used to link identities across multiple sources. Profile identifiers refer to static pieces of information associated with a unique user's digital activity that can be re-used to gather updated digital activity or validate information associated with the unique user. Identifiers can be native identifiers assigned by a source or a detected piece of information that fits a format of a well-know or discovered identifying data type. For example, information received that fits a telephone number, social network handle format, email address, etc. is marked as a profile data that can be further processed via the data analytics module 255 and validation module 260. In an example implementation, the profile discovery module 245 works with the data analytics module 255 to discover information patterns associated with a source to identify profile identifiers.

In an example implementation, a Name API can provide Name Normalization method that takes quasi-structured name data provided as a string and outputs the data in a structured manner. It also returns a likelihood based only on the order of the given name and family name as seen in the US population. For example, query parameters can include characters for names to be in the range of A-Z or a-z, Contains Name normalization, Name deducer, Name similarity, Name stats and Name parser sub-APIs, etc.

An email API can identify disposable email addresses or one time use email addresses so that you can take action at the time of user signup. The API detects known domains associated with disposable email addresses, and in addition detects sub addressing for domains where the behavior is known. A location API can perform Location Normalization and Location Enrichment for providing details based on location name detail descriptions.

The profile monitor 250 conducts active gathering of pieces of information using profile identifiers. In an example implementation, profile monitor 250 can monitor or crawl a digital source catalogue or index information that the records manager 265 uses to build repository entries. In another example implementation, the profile monitor 250 interacts with the validation module 260 to verify identifiers. The profile monitor 250 can track and log interactions between or among multiple profile identifiers that are further processed by the data analytics module 255 and records manager 265. For example, a social media service that allows users to share postings or use hashtags can be watched by the profile monitor 250 to track sharing activity or common hashtag usage by different profile identifiers.

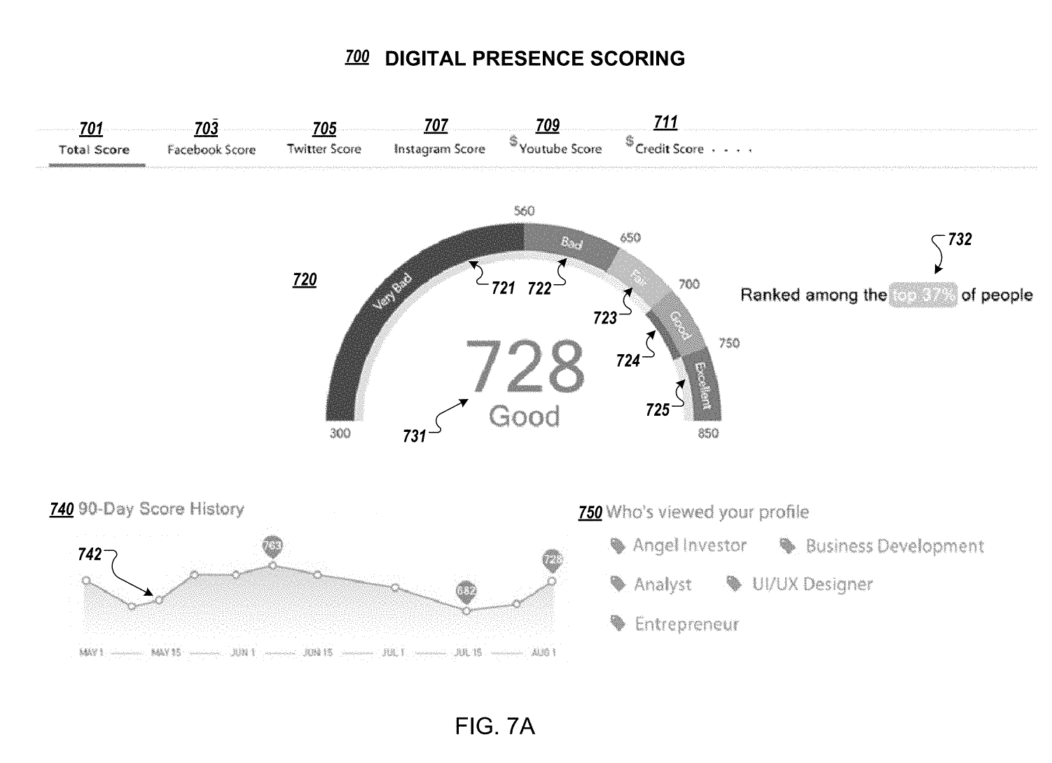

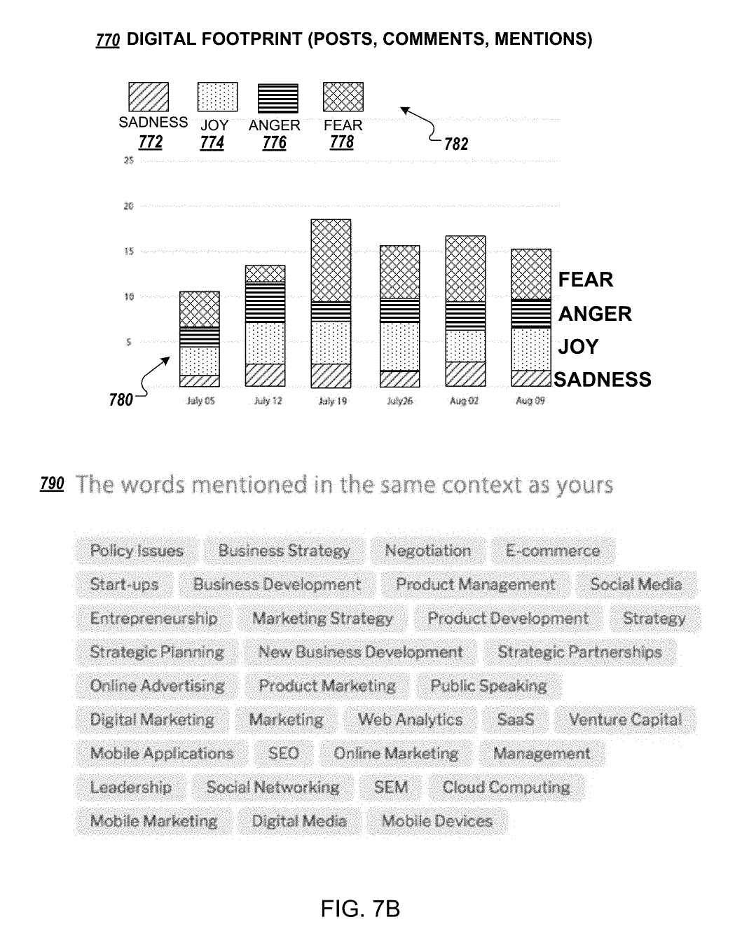

According to an example implementation profile monitor 250 can track digital activity across multiple sources in order to calculate a digital presence score. For example a twitter score can be calculated based on the frequency of postings, change in followers, number of shares, etc. The profile monitor 250 can maintain a historical log of activity for each source and develop statistics that measure relative changes in the historical log activity. According to an example implementation, digital presence profiler 220 can include a set of report interfaces as further described in reference to FIGS. 7A- B.

The data analytics module 255 and validation module 260 identify relevant information in the collected digital activity. In an example implementation, the validation module 260 can use the response interface 270 to prompt a user to validate relationships between pieces of information and/or identifiers.

Digital presence profiler 220 can perform data analytics to create search queries and associate information from collected digital activity. A record may be associated with a contact or a noncontact or combined with a mother profile of a contact or noncontact. For sets of information that correspond to multiple identifiers associated with different people, the contact information of the requesting user can be searched to determine a set of information that corresponds to the request. The data analytics module 255 identifies sets of information based on the contact information of the requesting user, and the validation module 260 can conduct comparison searches of the sets of information with the contact information to calculate a certainty score. For example, if a request returns five sets of information and one or more of the sets includes a geographic indicator of that matched the location data of the user.

The data analytics module 255 can generate social graph information of each of the records, including whether the individuals associated with the record are connected to one another record on a social networking service. The digital presence profiler 220 can use social graph information to validate search results as well as highlight digital activity in a report transmitted to the user. For example, but not by way of limitation, a user can view a chart of individual in an organization on a mobile computing device.

When the digital presence profiler 220 reports data from multiple social networking service (e.g., LinkedIn), a social graph can used to determine common connections between the target individual and the user across the multiple social networking services. The social graph is used to identify common groups, memberships, organizations, or the like. Social networking services may be combined together (e.g., using data analytics, records, or other indicia). As a result, the social graph information of the target individual and the user on various social networks may be overlaid, so that the data analytics module 255 can determine relationships between various common connections. For example, the social graph can be used to determine relationships between the target individual and the user who are members of the user's company. Social graphs are used by the data presence profiler 220 for managing profile identifiers and can be presented to a requesting user for validating relationships.

The validation module 260 can generate, track, and adjust validation scores for pieces of information or identifiers. Each piece of information of an identity record can receive a validation score. Information gathered by the data presence profiler 220 from an external source may be inaccurate or improperly associated with a target profile.

An initial validation score can be generated based on the source or sources of the piece of information, the type of information, or how often the piece of information correlates with the target profile. For example, an initial validation score can be based on the number of times the piece of information has been located from a different or separate source as associated with a name or network identifier.

When an email address appears on a social network profile and the same email address is returned from a third party database as associated with the target, the email address has been associated with the same target by multiple sources, thus the validation module can increase the validation score for the email address as a piece of information associated with the target.

In another example, if an email address appears on a social network profile page associated with a target profile maintained by the data presence profiler 220, and the social network profile page includes a telephone number, middle initial, profile picture, work history, age, etc. that correlates with the target profile, then the validation score for the email address can be adjusted based on the amount of information from the social network profile page that correlates with the target profile maintained by the data presence profiler 220.

In some example implementations, the validation score can be adjusted based (e.g., increased, multiplied, weighted, etc.) based on a source quality metric. For example, pieces of information from a user generated social network profile can receive a higher source quality metric than pieces of information from an computer generated database based on public records.

The source quality metric for each source can be adjusted dynamically by the data presence profiler 220 as users self-report invalid entries that originated from the source (e.g., website, database, etc.) The source quality metric for each source can be maintained based on feedback from multiple users and/or administrative controls.

As social network platforms rise and fall in popularity or become historical, the source quality metric can be adjusted to reflect that less popularity correlates with outdate data. For example, an old social network platform may have had accurate data during years of heavy user provided content, but as users migrated to a new social network platform, the data on the old social network platform becomes stale and potentially historical or outdated. The source quality metric can be adjusted based on an industry ranking or daily visitor count relative to similar sources or types of sources.

In some implementations, the response interface 270 prompts users to validate information gathered. User feedback for correcting invalid pieces of information can update the user profile and decrease the source quality metric for any sources with the invalid piece of information. In an example implementation, user feedback for confirming valid pieces of information can update the validation score for the piece of information and increase the source quality metric for any sources with the valid piece of information.

The validation score and/or source quality metric can be used to prioritize selecting of pieces of information to prompt the user to validate. User confirmed information can receive the highest validation score. User information provided directly to the data presence profiler 220 or information gathered by the data presence profiler 220 and confirmed by the user can receive a highest score. For example, a user can update to their profile to provide an email address or social network identifier that is considered valid information.

Validation scores can decrease or decay overtime at variable rates. As the data of the initial gathering of the information or date of user confirmation becomes further from a current date, the validation score for the piece of information can decrease or decay to reflect that the information has become stale or potentially outdated. For example, a user can confirm a social network identifier and months later deactivate the account associated with the identifier and/or activate a new or different account on the same social network platform.

The response interface 270 provides conversational output of the digital presence profiler 220. In an example implementation, conversational output of the response interface 270 can provide request results, validation ques, and/or control options, for example, registered user data management. In an example implementation, registered user data management allows registered users to validate profile data generated by the digital presence profiler 220 and control access settings for data associated with the registered user.

The digital presence profiler 220 can accumulate information that might be related to a noncontact. Then the follow-up question can be asked in order to determine which set of accumulated information is associated with a contact versus a noncontact. In an example, a user may initiate a conversation with a chatbot request interface 225 to submit a request for a piece of information. The request interface 225 can use the records manager 265 and the digital activity module 235 to gather relevant available information for the data analytics module 255 and validation module 260 to process. To determine a noncontact, if the digital presence profiler 220 already has contact information but is missing a telephone number and the accumulated information includes a contact number that may be associated with the noncontact, then a follow-up question might be “would your contact have a phone number with an area code associated with the [geographic region]?” where the geographic region is dynamically populated based on the accumulated information.

In response to accumulating information that satisfies the request, the response interface 270 can present the information and generate one or more follow-up questions to confirm the presented information satisfies the user request. The request interface 225 determines follow-up questions to ask based on logic that reviews the accumulated information as well as previously stored user information.

In response to accumulating information that does not satisfy the request, response interface 270 can generate one or more follow-up questions based on the located information to develop an updated request or update associations of the accumulated information that does not satisfy the request. For example, accumulated information may be associated with multiple people that match the first request, a the requesting user's contacts storage can be analyzed to filter out accumulated information not matching contact thereby eliminating one or more of the multiple people. For multiple potential results, the response interface 270 can ask the requesting user to answer one or more questions that differentiate the multiple people. For example, a requested search term may result in multiple sets of data being identified. Then the validation module 260 and data analytics module 255 can sort and organize the multiple sets of data into separate potential profiles or records.

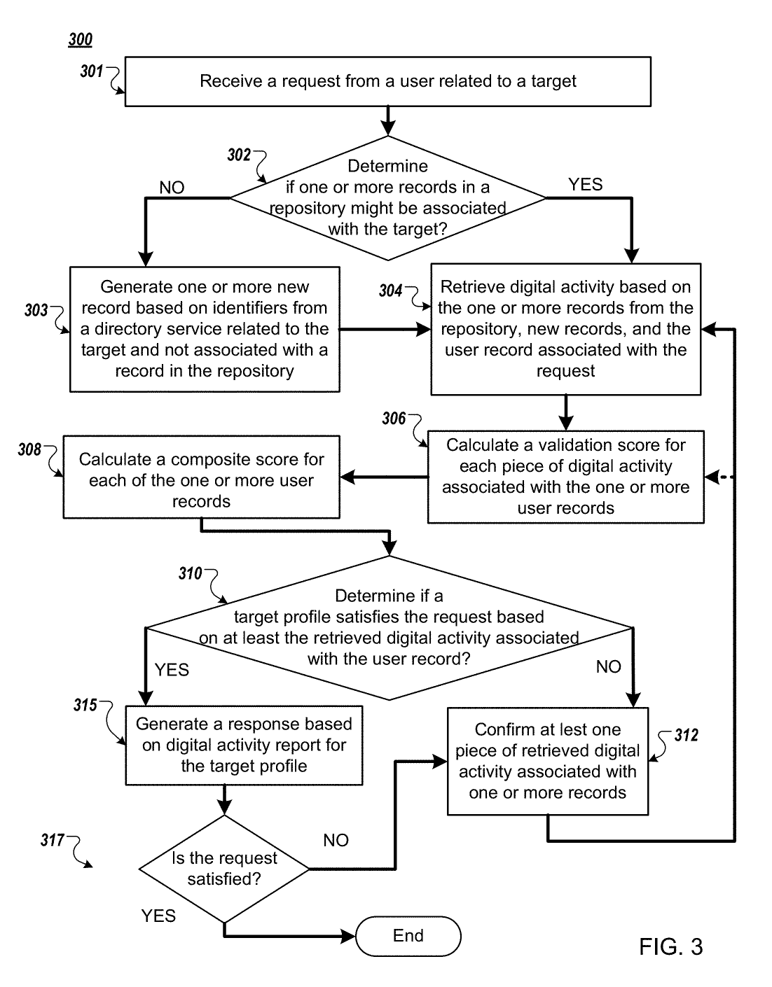

FIG. 3 is a flow diagram 300 of an example method in accordance with one or more implementations of the present disclosure. In an example implementation, a method can be performed by processing logic that can comprise hardware (e.g., circuitry, dedicated logic, programmable logic, microcode, etc.), software (e.g., instructions run on a processing device), or a combination thereof. In an implementation, the method is performed by a digital presence profiler (e.g., digital presence profiler 120 of FIG. 1 and digital presence profiler 220 of FIG. 2) executed by a processing device. The digital presence profiler can be a cloud service in communication with users via other online communication platforms (e.g., artificial intelligent platforms, mobile device applications, websites, etc.).

At block 301 the processing device receives a request from a user related to a target. For example, a user can request the processing device retrieve a detail or fact about an individual by providing only limited information such as an email address, telephone number, name, etc. For example, a request might include “Do I know anyone who speaks Chinese?” and the digital activity report can respond “Zhao Wei, Fan Bingbing, and Jian Tian can speak Chinese.” In another example, a request might include “I'm going to Hawaii. Do I know anyone who has been there?” and the digital presence profiler can use the requesters user data to search social media connections for biographical information, pictures, postings, etc. associated with Hawaii.

At block 302, the processing device determines if records in a repository are associated with the target. For example, a record might be associated with the target if an identifier matches a name of the target. Records that include common names or identifiers may be returned more frequently than records with uncommon names or identifiers. Accordingly, a request for a target that includes a common name, identifier, domain, company, etc. can be return several records. A broad search of the repository is conducted to return matches as well as potential matches.

In some implementations, the processing device will create a record each time a new target is identified. The record can store identifiers associated with the target. Each time the processing device receives a request for information relating to the target, processing device can generate queries in real time by combining the request, identifiers from the record, as well as data associated with the user to generate search queries in real time for up-to-date digital activity from online sources. That is, the record stores identifiers or search keys that can include, for example, profile names, telephone numbers, social networks, demographic information, etc. in order to efficiently and intelligently collect the latest digital activity available across multiple sources and different types of networks associated with a target.

The processing device can actively update the record with new search results as identifiers. In some implementations, the processing device can maintain a listening mode or monitoring service for particular targets. For example, the processing device can run a scheduled search to regularly update records for a user. In response to determining that a record in the repository is associated with the target, processing device can use the stored identifiers at block 304 to retrieve digital activity associated with the target.

The processing device can also add individuals to the repository by generating new records at block 303. In some implementations, records can be merged or linked as isolated or unrelated information becomes validated or confirmed with another record at blocks 306, 308, and/or 312.

Processing device can generate an empty record for a request, perform broad searches of available information to generate a first set of identifiers, request identifiers from a third-party ID provider, request additional information from the requesting user, etc. to populate the record. The processing device includes record management to deduplicate or link records for a target. Registered users of the digital presence profiler can manage information to enhance their record and the processing device can use the user's digital activity to enhance the registered user's record.

At block 304, the processing device retrieves digital activity based on the one or more records from the repository or new records as well as based on the user record associated with the requester.

At block 306, the processing device calculates a validation score for each piece of digital activity associated with the one or more records. The validation score for a piece of information can be calculated based on the strength of the association with the record. For example, a piece of information from a social media page, where the social media page includes several other pieces of information or identifiers that match the record can receive a validation score based on the number of matches. In some implementations, the validation score can be weight based on the source of information.

At block 308, a composite score for each of the one or more user records can be calculated based on the validation scores for each piece of digital activity retrieved and/or confirmed information associated with the record, as described at block 312.

At block 310, the processing device determines whether a target profile satisfies the request based on at least the retrieved digital activity associated with the user record. Multiple profiles may be associated with the retrieved digital activity and/or the user record. The processing device can select a best target profile from the multiple profiles based on the calculated composite score. The processing device can further run logic to determine if the best profile includes information (e.g., pieces of digital activity, record information, identifiers, etc.) that satisfy the request.

In some implementations, at block 312, a confirmation sequence can be initiated to review a piece of information associated with a target profile and/or prompt the requesting user to provide additional information. In an example implementation, confirmation information can filter out a target profile from a set of multiple profiles. For example, if multiple profiles satisfy the request or no profiles satisfy the request, the processing device can prompt the user to rephrase the request, provide additional details related to the request or target profile, or eliminate one or more of the records. For example, the user can provide geographic information, relationship information, or other information that eliminates one or more of the profiles.

The confirmation process at block 312 can include soliciting a person to confirm that a piece of digital activity is related to a target profile. For example, the processing device can present a geographic location, company information, or school history retrieved for a record at 304 to confirm the information is related to the target that satisfies the request and/or eliminate a record from the set of profiles.

In some example implementations, the confirmation process at 312 can crowd source to have one or more users other than the requesting user to confirm whether a piece of information is associated with a target profile. That is, another user that previously accessed on of the profiles can be prompted whether a piece of information is accurately related to the profile. For example, another user may interacted with a profile for Jason Smith that works Acme, Inc. and have personal knowledge to confirm or eliminate a school information related to that Jason Smith profile.

After the confirmation sequence, one or more steps of the process can be repeated to iteratively determine at block 310 whether a target satisfies the request. The confirmation response can be used to update the records in the repository as confirmed information to adjust (e.g., increase, decrease, etc.) an associated validation score. After a piece of information is confirmed (or eliminated) as being associated with a record at 312, the processing device can return to block 304 to retrieve updated information and/or block 306 to recalculate the validation score.

In some example implementations, confirmation response information can used to retrieve additional digital activity based on the one or more records from the repository, new records, and the user record associated with the request. The additional digital activity with the validation information can be used to determine a target profile that satisfies the request.

In response to a target profile based the retrieved digital activity associated with the user record satisfies the request, at block 315, processing device generates a response based on digital activity report for the target profile. The processing device transmits the response for presentation to the user. For example, the response can be delivered via a chatbot, messenger service, automated assistant, a text message, etc. At block 317, the processing device can optionally confirm that the response satisfied the request to end the process.

If the requesting user was not satisfied with the returned information, the confirmation sequence can retrieve additional information to provide an updated result. The confirmation sequence can also be performed asynchronously or independent from a request to improve the validated information in the repository. As usage of the platform increases, the quality of confirmed information improves the satisfaction rate of the request response.

FIG. 4A is illustrates example record data in accordance with one or more implementations of the present disclosure. In an example implementation, the digital presence profiler generates link records 405 that includes an index of keys and/or registered link data 410 stored in a repository. As illustrated, identifiers can include source created IDs, (e.g., social medial profile identifiers, corporate tokens, device identifiers, etc.) that are anonymized or semi-anonymized, personally identifiable information (e.g., sensitive or non-sensitive contact information, organizations, memberships, etc.) user behaviors (e.g., internet postings, search or request history, etc.).

The digital presence profiler uses updated digital activity to identify associations and develop search results. Rather than relying simply on static identifiers or archived content, the digital presence profiler develops link records 405 that are used to actively gather and analyze digital activity to generate profile information.

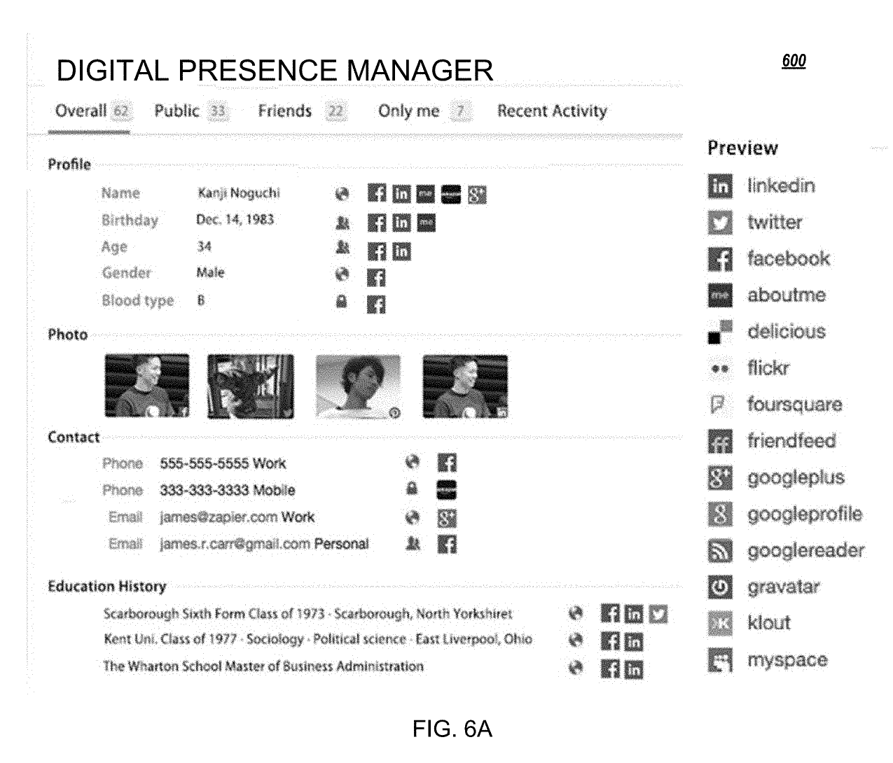

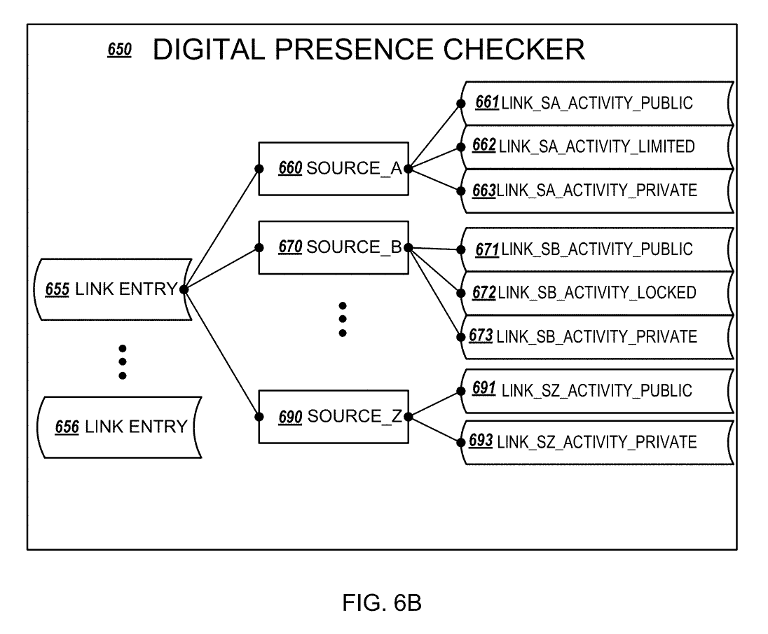

Link records 405 can be generated using publically accessible sources and/or accessed using authorization from a registered user. Link records 405 or elements of link records 405 created using authorization from a registered user can be restricted for use by the registered user. According to example implementations, registered users can manage and control link records 405 including registered link data. For example, a registered user can access a control panel (e.g., digital presence checker 650 of FIG. 6B) or interact with a chat interface to manage access and visibility of information.

The digital presence profiler can use the identity link record 405 and can registered user link data 410 to preform searches. For example, if the person associated with the record of linked data is a registered user of the platform, a first sub index can include a platform profile comprising user provided personal identifiable information. A second source for generating entries into the record of linked data can come from the requesting party's storage. For example, the processing module can receive a request to identify a target subject from the requesting party. The processing module can search a storage device associated with the requesting party for information associated with the user or the target subject.

In an example implementation, the processing module can use the information associated with target subject as a first set of keys or identifiers in the record of linked data. The processing module can request additional identifiers from an ID provider using the information from the request and/or additionally the information from the requesting parties storage associated with target subject. The additional identifiers from the ID provider can serve as a second set of identifiers in the record of linked data. The processing module can perform a first phase search based on the first and second set of identifiers. A first phase search may include searching for biographical or profile entries based on the first and second set of identifiers. The first phase search can return biographical information based on the first phase search additional identifiers may be added to the record of linked data for the target subject.

The processing module can perform a second phase search using the updated record of linked data. In some example implementations, the first phase search may be directed to a first set of directory sources and the second phase search may be directed to nondirect resources that can include message boards, photo captions, embedded content, supplemental content, etc.

Registered user link data 410 can be gathered, when authorized by a registered user, to associate user behaviors with digital activity. For example, a registered user my grant access to call history, calendars, emails, location data, files, search history, tokens, etc. to improve search results. The digital presence profiler can gather interaction data from the registered link data 410 to monitor digital activity associated with contacts. Accordingly, digital presence profiles can be gathered based on attendees for a meeting in a calendar or email activity.

Updated digital activity is used to identify associations and develop search results. In an example implementation, registered link data 410 is used to validate digital activity. In an example, location data of the registered user can be used to adjust confidence of digital activity accumulated for a search based on corresponding location information.

For example, a user's recent vacation location can be used to improve search results for a request and locate newly established connection. General information might be used to locate multiple profiles associated with a common name, Jason Smith, which satisfy a search request. Overlapping static profile information might filter the multiple profiles associated with a common name; however, newly updated digital activity might increase the number of profiles that would otherwise be filtered. By using link records 405 to gather recent digital activity, the digital presence profiler identifies links between profiles that otherwise could not be developed using static profile information. For example, a newly established connection made with a person while on vacation can be return with high confidence by using a registered user's link data 410. In the example, search results can be improved based on a recent private data of a registered user that corresponds with digital activity of one or more of the search results.

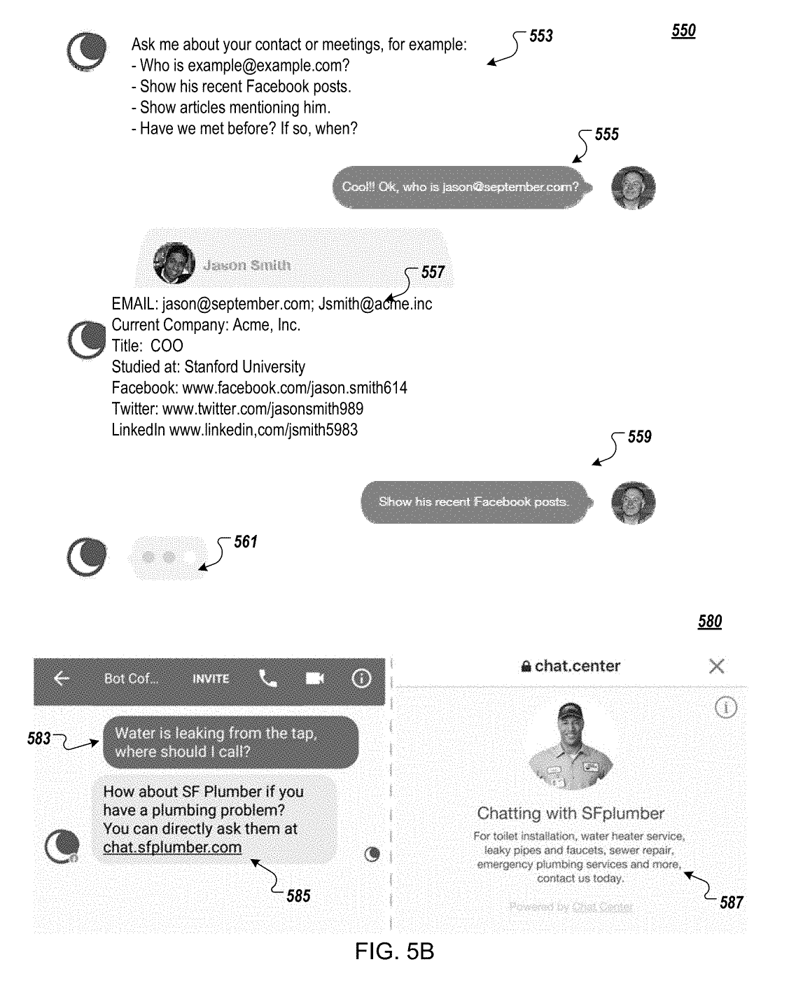

FIG. 5A illustrates an example digital activity payload in accordance with one or more implementations of the present disclosure. Digital activity can come from various sources to provide a user with up-to-date information assembled in real time and validated against the user information. For example, when meeting with a new acquaintance, a request for digital activity may return information such as social media posts, social networks, affiliated organizations, demographic information, online presence score, new stories, location information, image results, etc. The user may also be presented with digital activity relating to the user's data and request. For example, the digital presence profiler can present the a digital activity payload user's data relating to the target such as recent email messages, recent calls, upcoming meetings, common contacts, common locations, common organizations, etc.

FIG. 5B illustrates example user interactions to retrieve digital activity payload in accordance with one or more implementations of the present disclosure. A digital presence agent can interact directly with a user or via one or more services. For example, a chat interface can connect directly to the digital presence agent or to a virtual assistant that interacts with the digital presence agent.

At 553, the digital presence agent can prompt the user to provide a request, such as “Ask me about your contact or meetings, for example: Who is example@example.com? Show his recent Facebook posts. Show articles mentioning him. Have we met before? If so, when?” At 555, the user can provide a request that include a search identifier, for example “ who is Jason@September?” or “When did I last meet [contact]?”

In response to the request, the digital presence agent can generate a search query to determine one or more profile, locate identifiers associated with each of the profiles, and accumulate digital activity associated with each of the profiles. The digital presence agent can determine a target profile to satisfy the request by validating the accumulated digital activity analyzed in view of the requesting user's information.

For example, the accumulated digital activity can indicate the requested email address us from an expired domain, the requested email address is listed as part of a social network profile page, the social network profile page lists the old domain, a current company, and another email address associated with the new company. The digital presences agent can use the accumulated digital activity from the social network and validate the information using third party resources. For example, further searches of link data for the target and search data for the current company can return a position title for the target at the new company.

At 557, the digital presence agent can return a digest of the accumulated information with the highest validation scores that satisfy the request. The digest can include one or more suggestions for the requesting user to validate the data or request additional information. For example, providing additional personally identifiable information, such as a school associated with the target profile, can indicate to the user if the digest is accurate. For example, the user can respond, “I think Jason attended Berkley University; not Stanford.” Alternatively, the user can access additional information based on the digest returned for the target.

At 559, the user might further request “show his recent Facebook posts” At 561, the digital presence agent can access the social media network via an API to gather recent activity that is accessible. In some implementations, the requesting user can provide login information for the social media network and authorize the digital presence agent access restricted information using the provided login information.

In an example implementation, at 580 a user can provide a broad request to a chat interface. For example, a broad request for “water is leaking the sink, who should I call?” can the digital presence agent can locate contact information for a plumbing service based on the user's location, prior search history, etc.

In another example, a user can request “I am traveling to [LOCATION] next month. Who can I ask for advice where to eat?.” The digital presence agent can conduct a search as described above to generate a response, such as “I found [CONTACT] recently posted pictures from [LOCATION] on Facebook. Would you like me to send him an email?”

In another example, a user can request, “Who do I know that can speak Chinese?”. The digital presence agent can conduct a search as described above to generate a response, such as “Your co-worker [CONTACT] is fluent in Chinese and worked in [Beijing from 2007-2014].”

FIG. 6A illustrates an example digital presence manager 600 in accordance with one or more implementations of the present disclosure. Digital presence manager 600 provides an interface to allow a person to check, confirm, remove, or lock pieces of information associated with a profile. In an example implementation, digital presence manager 600 interface can show a limited visualization of aggregated digital activity or identifiers of another user that a person can confirm or eliminate. For example, a profile can be confirmed using crowd sourcing. In an example implementation, digital presence manager 600 interface is for a registered user to lock or control pieces of information and/or identifiers.

The digital presence manager 600 provides controls to user to review accessible information and restrict access by the digital presence agent to specific pieces of information. For example, a user can quickly review sources with personally identifiably information based on digital presence information accessible to the digital presence profiler. The digital presence manager 600 works with digital presence checker 650 to preview digital activity results from different sources and restrict the digital presence profiler from sharing pieces of information with other users. For example, the digital presence manager 600 provides the registered user with a list of sources that return matching name and birthdate information. The digital presence manager 600 can gather link data from a registered user to access or validate sources. For example, the registered user can authorization via the digital presence manager 600 to access the registered user's social media profiles, email accounts, calendar etc.

FIG. 6B illustrates an example digital presence checker 650 in accordance with one or more implementations of the present disclosure. Digital presence checker 650 can include an interface or messenger service that allows users to review link data and manage visibility of information. The digital presence checker 650 uses link entries 655, 656 of the registered user to check digital activity 661-663 from different sources 660, 670, 690, etc. The digital presence checker 650 can run different requests to each source with different authorizations provided by the registered user. The digital presence manager 600 can indicate if the information is publicly available, limitedly available, or restricted based on digital activity gathered by the digital presence checker 650.

FIGS. 7A-B illustrate example digital presence scoring and tracking interfaces in accordance with one or more implementations of the present disclosure. FIG. 7A illustrates an example digital presence scoring interfaces 700 in accordance with one or more implementations of the present disclosure.

FIG. 7B illustrates example digital presence footprint interface 770 and a term cloud 790 in accordance with one or more implementations of the present disclosure.

Digital presence scoring 700 provides an interface to show aggregated digital activity. In an example implementation, digital presence scoring 700 interfaces shows aggregate digital activity for a registered user. In another example implementation, digital presence interface 700 can show a limited visualization of aggregated digital activity of another user. When viewing aggregated digital activity of another user, information may be filtered, limited, locked, abstracted, etc.

The digital presence scoring 700 can include scores calculated for one or more sources in a composite score 701. For example, Facebook® score 703, Twitter® scores 705 Instagram® score 707 YouTube® score 709, credit score 711, etc. The digital presence scoring 700 can include reports, digest, or other visualizations such as a digital presence footprint graph 770, word cloud 790, ranking 732, histograph 740, etc. In an example implementation the word cloud can include words mentioned in the same context as postings

A source score measures relative changes in activity based on a time interval. For example, the digital presence profiler can monitor or conduct searches for new digital activity that is compared to previous periods of monitoring or previous searches to measure changes in a person's digital activity.

A score can be calculated based on the type of source. For example some sources may be interactive or passive. In some implementations, sources may provide access to usage or analytics regarding activity associated with a user at or on the source. For example a social media platform may provide information regarding click count, likes, retweets, shares, postings, updates, etc.

To gather social media activity from a platform, the digital presence profiler can monitor postings via APIs associated with an interactive platform. Other sources may be passive and publish information that includes an identifier or piece of information associated with a profile. Passive sources may routinely or infrequently include a mention of the person. For example, a company leader may be mentioned in publications or blogs. Further the score associated with a passive source can be adjusted based on a number of shares or clicks of the passive source or publication.

Some source scores can include categorization of the activity on the source. Categorization of the activity may also depend on the type of source associated with the activity. Categorization of activity can be determined based on analyzing context of the activity. For example, context of the activity can include the target audience for a source, a topic analysis of a blog posting, or sentiment analysis of a posting, etc.

In an example implementation, categorization of activity for a interactive posting can include sentiment analysis. Sentiment analysis can measure word usage of the activity, use natural language processing techniques to determine sentiment of particular words in the measured word usage, and determine a sentiment for the activity. For example, a person may post on social media that they are sad, angry, fearful, joyful regarding a particular event or topic. In addition to categorizing the activity based on the topic, the sentiment analysis can identify one or more types of sentiments for the activity.

A total or composite score can be calculated by combining one or more of the source scores. The digital presence scoring 700 interface can include controls to suppress or remove and individual source score from the composite total score 701. The digital presence scoring 700 interface can be used with the digital presence manager 600 alert users of digital activity and confirm or eliminate the digital activity from being associated with their profile.

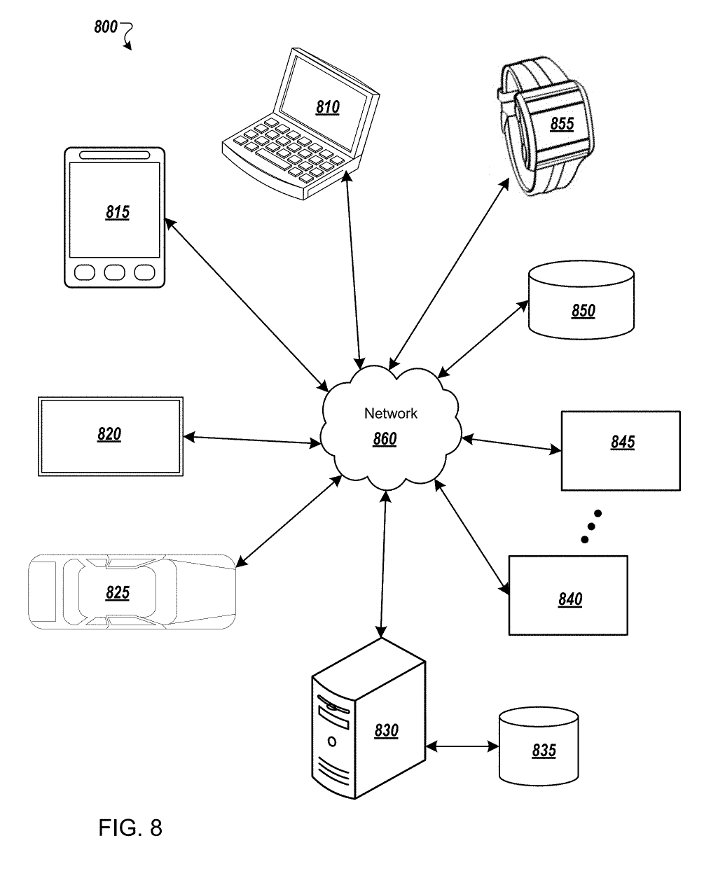

FIG. 8 shows an example environment suitable for some example implementations of the present application. Environment 800 includes devices 810-355, and each is communicatively connected to at least one other device via, for example, network 860 (e.g., by wired and/or wireless connections). Some devices may be communicatively connected to one or more storage devices 835 and 850.

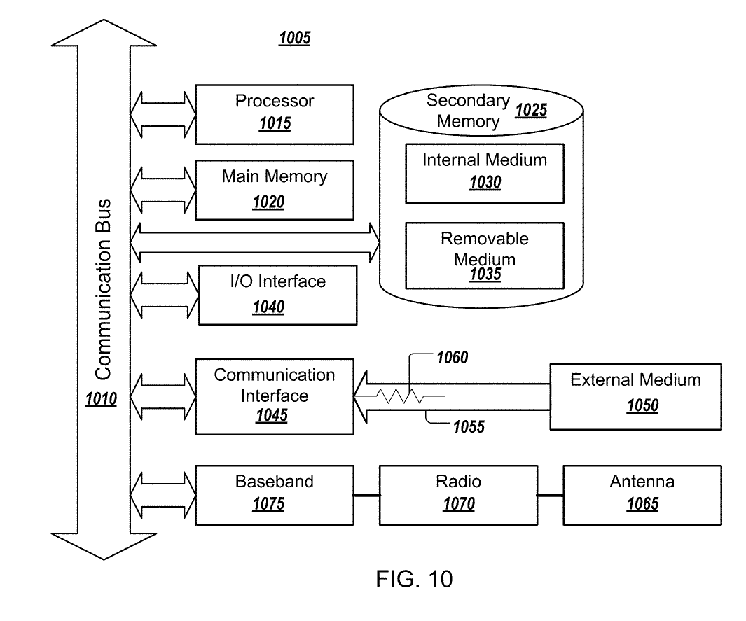

An example of one or more devices 810-355 may be computing device 805 described in FIG. 10. Devices 810-355 may include, but are not limited to, a computer 810 (e.g., a laptop computing device), a mobile device 815 (e.g., smartphone or tablet), a television 820, a device associated with a vehicle 825, a server computer 830, computing devices 840-345, storage devices 835 and 850 and wearable device 855.

In some implementations, devices 810-325 and 855 may be considered user devices (e.g., devices used by users to access the digital presence profiler platform, submit requests, provide additional identifiers, and receive a digital activity report). Devices 830-350 may be devices associated with one or more other platforms or online service that interact with the digital presence profiler platform.

For example, a user (e.g., Alice) may access an artificial intelligence service platform, submit a request via a voice command, that is received by the digital presence profiler platform and receive a digital activity report using user device 810 or 815 supported by one or more devices 830-350.

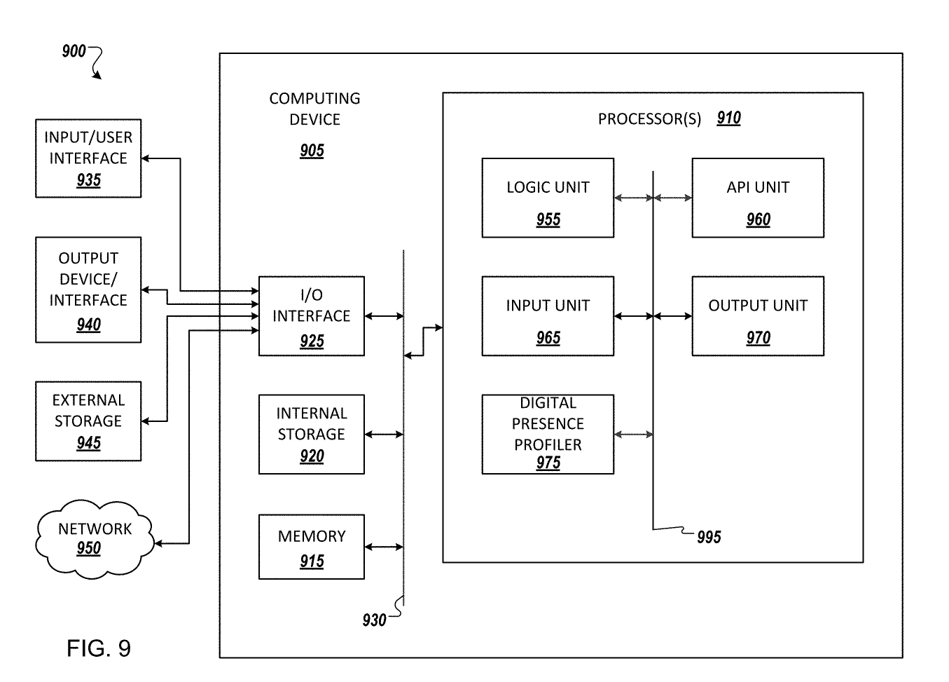

FIG. 9 illustrates an example computing environment 900 with an example computer device 905 suitable for use in some example implementations. Computing device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computing device 905.

Computing device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computing device 905. In other example implementations, other computing devices may function as or provide the functions of input/user interface 935 and output device/interface 940 for a computing device 905.

Examples of computing device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 905 can be communicatively coupled (e.g., via I/O interface 925) to external storage 945 and network 950 for communicating with any number of networked components, devices, and systems, including one or more computing devices of the same or different configuration. Computing device 905 or any connected computing device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computing device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 955, application programming interface (API) unit 990, input unit 965, output unit 970, digital presence profiler 975, information transmitting unit 990, and inter-unit communication mechanism 995 for the different units to communicate with each other, with the OS, and with other applications (not shown). For example, digital presence profiler 975, information transmitting unit 990 may implement one or more processes shown in FIGS. 8 and 10. The described units and elements can be varied in design, function, configuration, or implementation and are not limited to the descriptions provided.

In some example implementations, when information or an execution instruction is received by API unit 960, it may be communicated to one or more other units (e.g., logic unit 955, input unit 965, output unit 970, digital presence profiler 975, and information transmitting unit 990). For example, when a social media post is received via the input unit 965, the digital presence profiler t 975 may analyze the post to detect an identifier associated with a target individual. Additionally, when the digital presence profiler 975 collects digital activity, the output unit 970 may also send a digital activity report to a user or other service.

In some instances, the logic unit 955 may be configured to control the information flow among the units and direct the services provided by API unit 960, input unit 965, output unit 970, post detecting unit 975, and information transmitting unit 990 in some example implementations described above. For example, the flow of one or more processes or implementations may be controlled by logic unit 955 alone or in conjunction with API unit 960.

FIG.10 provides a block diagram illustrating an example computing device or system that may be used in connection with various example implementations described herein. For example, the system 1005 may be used as or in conjunction with one or more of the mechanisms or processes described above, and may represent components of processors, user system(s), and/or other devices described herein. The system 1005 can be a server or any conventional personal computer, or any other processor-enabled device that is capable of wired or wireless data communication. Other computer systems and/or architectures may be also used, as will be clear to those skilled in the art.

The system 1005 preferably includes one or more processors, such as processor 1015. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1015. Examples of processors which may be used with system 1005 include, without limitation, the Pentium® processor, Core i7® processor, and Xeon® processor, all of which are available from Intel Corporation of Santa Clara, Calif.

The processor 1015 is preferably connected to a communication bus 1010. The communication bus 1010 may include a data channel for facilitating information transfer between storage and other peripheral components of the system 1010. The communication bus 1010 further may provide a set of signals used for communication with the processor 1015, including a data bus, address bus, and control bus (not shown). The communication bus 1010 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE1088 general-purpose interface bus (GPIB), IEEE 696/S-30, and the like.

System 1005 preferably includes a main memory 1020 and may also include a secondary memory 1025. The main memory 1020 provides storage of instructions and data for programs executing on the processor 1015, such as one or more of the functions and/or modules discussed above. It should be understood that programs stored in the memory and executed by processor 1015 may be written and/or compiled according to any suitable language, including without limitation C/C++, Java, JavaScript, Pearl, Visual Basic, .NET, and the like. The main memory 1020 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 1025 may optionally include an internal memory 1030 and/or a removable medium 1035, for example a floppy disk drive, a magnetic tape drive, a compact disc (CD) drive, a digital versatile disc (DVD) drive, other optical drive, a flash memory drive, etc. The removable medium 1035 is read from and/or written to in a well-known manner. Removable storage medium 1035 may be, for example, a floppy disk, magnetic tape, CD, DVD, SD card, etc.

The removable storage medium 1035 is a non-transitory computer-readable medium having stored thereon computer executable code (i.e., software) and/or data. The computer software or data stored on the removable storage medium 1035 is read into the system 1005 for execution by the processor 1015.

In alternative example implementations, secondary memory 1025 may include other similar means for allowing computer programs or other data or instructions to be loaded into the system 1005. Such means may include, for example, an external storage medium 1050 and an interface 1045. Examples of external storage medium 1050 may include an external hard disk drive or an external optical drive, or and external magneto-optical drive.

Other examples of secondary memory 1025 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 1035 and communication interface 1045, which allow software and data to be transferred from an external medium 1050 to the system 1005.

System 1005 may include a communication interface 1045. The communication interface 1045 allows software and data to be transferred between system 1005 and external devices (e.g. printers), networks, or information sources. For example, computer software or executable code may be transferred to system 1005 from a network server via communication interface 1045. Examples of communication interface 1045 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 1005 with a network or another computing device.

Communication interface 1045 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 1045 are generally in the form of electrical communication signals 1060. These signals 1060 are preferably provided to communication interface 1045 via a communication channel 1055. In one example implementation, the communication channel 1055 may be a wired or wireless network, or any variety of other communication links. Communication channel 1055 carries signals 1060 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1020 and/or the secondary memory 1025. Computer programs can also be received via communication interface 1045 and stored in the main memory 1020 and/or the secondary memory 1025. Such computer programs, when executed, enable the system 1005 to perform the various functions of the present invention as previously described.

In this description, the term “computer readable medium” is used to refer to any non-transitory computer readable storage media used to provide computer executable code (e.g., software and computer programs) to the system 1005. Examples of these media include main memory 1020, secondary memory 1025 (including internal memory 1030, removable medium 1035, and external storage medium 1050), and any peripheral device communicatively coupled with communication interface 1045 (including a network information server or other network device). These non-transitory computer readable mediums are means for providing executable code, programming instructions, and software to the system 1005.

In an example implementation that is implemented using software, the software may be stored on a computer readable medium and loaded into the system 1005 by way of removable medium 1035, I/O interface 1040, or communication interface 1045. In such an example implementation, the software is loaded into the system 1005 in the form of electrical communication signals 1060. The software, when executed by the processor 1015, preferably causes the processor 1015 to perform the inventive features and functions previously described herein.

In an example implementation, I/O interface 1040 provides an interface between one or more components of system 1005 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 1005 also includes optional wireless communication components that facilitate wireless communication over a voice and over a data network. The wireless communication components comprise an antenna system 1065, a radio system 1070, and a baseband system 1075. In the system 1005, radio frequency (RF) signals are transmitted and received over the air by the antenna system 1065 under the management of the radio system 1070.

In one example implementation, the antenna system 1065 may comprise one or more antennae and one or more multiplexors (not shown) that perform a switching function to provide the antenna system 1065 with transmit and receive signal paths. In the receive path, received RF signals can be coupled from a multiplexor to a low noise amplifier (not shown) that amplifies the received RF signal and sends the amplified signal to the radio system 1070.

In alternative example implementations, the radio system 1070 may comprise one or more radios that are configured to communicate over various frequencies. In one example implementation, the radio system 1070 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 1070 to the baseband system 1075.

If the received signal contains audio information, then baseband system 1075 decodes the signal and converts it to an analog signal. Then the signal is amplified and sent to a speaker. The baseband system 1075 also receives analog audio signals from a microphone. These analog audio signals are converted to digital signals and encoded by the baseband system 1075. The baseband system 1075 also codes the digital signals for transmission and generates a baseband transmit audio signal that is routed to the modulator portion of the radio system 1070. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1065 where the signal is switched to the antenna port for transmission.

The baseband system 1075 is also communicatively coupled with the processor 1015. The central processing unit 1015 has access to data storage areas 1020 and 1025. The central processing unit 1015 is preferably configured to execute instructions (i.e., computer programs or software) that can be stored in the memory 1020 or the secondary memory 1025. Computer programs can also be received from the baseband processor 1065 and stored in the data storage area 1020 or in secondary memory 1025, or executed upon receipt. Such computer programs, when executed, enable the system 1005 to perform the various functions of the present invention as previously described. For example, data storage areas 1020 may include various software modules (not shown).

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
receiving, from a user, a request related to a target;
determining if one or more records in a repository are associated with the target, each record includes identifiers for retrieving digital activity associated with an individual from a plurality of environments;
generating one or more new record based on identifiers from a directory service related to the target and not associated with a record in the repository;
retrieving digital activity based on the one or more records from the repository, new records, and the user record associated with the request;
determining a target profile based on at least the retrieved digital activity associated with the user record;
generating a response based on digital activity for the target profile; and
transmitting the response.

2. The method of claim 1, wherein determining the target profile based on at least the retrieved digital activity associated with the user record further comprises:
receiving, a set of user results from memory associated with the user based on the request; and
generating a validation data set comprising at least the set of user query results;

3. The method of claim 2, wherein the memory associated with the user is a cloud storage.

4. The method of claim 2, wherein the memory associated with the user is a local storage.

5. The method of claim 1, wherein the wherein the repository includes a plurality of records for registered users and unregistered users, wherein a record of a registered user comprises identifiers and authentication information for accessing one or more resources.

6. The method of claim 1, wherein retrieving digital activity further comprise producing a combined search query, wherein the combined search query includes normalized search terms based on at least one of the one or more identifiers of the records or request.

7. The method of claim 1, wherein determining if one or more records in a repository are associated with the target comprises normalizing terms in the request term and performing a fuzzy search based on the normalized terms.

8. A system comprising:
a repository with a plurality of records, each record includes identifiers for retrieving digital activity associated with an individual from a plurality of environments;
a processor, operatively coupled to the repository, the processor to:
receive, from a user, a request related to a target;
determine if one or more records in the repository are associated with the target;
generate one or more new record based on identifiers from a directory service related to the target and not associated with a record in the repository;
retrieve digital activity based on the one or more records from the repository, new records, and the user record associated with the request;
determine a target profile based on at least the retrieved digital activity associated with the user record;
generate a response based on digital activity for the target profile; and
transmit the response.

9. The system of claim 8, wherein determining the target profile based on at least the retrieved digital activity associated with the user record further comprises:
receive, a set of user results from memory associated with the user based on the request; and
generate a validation data set comprising at least the set of user query results;

10. The system of claim 9, wherein the memory associated with the user is a cloud storage.

11. The system of claim 9, wherein the memory associated with the user is a local storage.

12. The system of claim 8, wherein the wherein the repository includes a plurality of records for registered users and unregistered users, wherein a record of a registered user comprises identifiers and authentication information for accessing one or more resources.

13. The system of claim 8, wherein retrieving digital activity further comprise producing a combined search query, wherein the combined search query includes normalized search terms based on at least one of the one or more identifiers of the records or request.

14. The system of claim 8, wherein to determine if one or more records in a repository are associated with the target comprises to normalize terms in the request term and perform a fuzzy search based on the normalized terms.

15. A non-transitory computer readable medium having stored therein computer executable instructions to:
receive, from a user, a request related to a target;
determine if one or more records in a repository are associated with the target, each record includes identifiers for retrieving digital activity associated with an individual from a plurality of environments;
generate one or more new record based on identifiers from a directory service related to the target and not associated with a record in the repository;
retrieve digital activity based on the one or more records from the repository, new records, and the user record associated with the request;
determine a target profile based on at least the retrieved digital activity associated with the user record;
generate a response based on digital activity for the target profile; and
transmit the response.

16. The non-transitory computer readable medium of claim 15, wherein determining the target profile based on at least the retrieved digital activity associated with the user record further comprises:
receive, a set of user results from memory associated with the user based on the request; and
generate a validation data set comprising at least the set of user query results;

17. The non-transitory computer readable medium of claim 15, wherein the wherein the repository includes a plurality of records for registered users and unregistered users, wherein a record of a registered user comprises identifiers and authentication information for accessing one or more resources.

18. The non-transitory computer readable medium of claim 15, wherein retrieving digital activity further comprise producing a combined search query, wherein the combined search query includes normalized search terms based on at least one of the one or more identifiers of the records or request.

19. The non-transitory computer readable medium of claim 15, wherein to determine if one or more records in a repository are associated with the target comprises to normalize terms in the request term and perform a fuzzy search based on the normalized terms.
